(19) United States
(12) Patent Application Publication
(10) Pub. No.: US 2006/0155724 A1
(43) Pub. Date: Jul. 13, 2006

(54) Loop channels

(75) Inventors: Prescott V. Lee, Menlo Park, CA (US); Kyle S. Mashima, Menlo Park, CA (US)

Correspondence Address: CARR & FERRELL LLP, 2200 GENG ROAD, PALO ALTO, CA, 94303, US

(73) Assignee: FilmLoop, Inc.

(21) Appl. No.: 11/173,211

(22) Filed: Jul. 1, 2005

Related U.S. Application Data
(60) Provisional application No. 60/644,254, filed on Jan. 13, 2005.
(60) Provisional application No. 60/644,129, filed on Jan. 13, 2005.

(51) Int. Cl. G06F 7/00

(52) U.S. Cl. 707/100

(57) ABSTRACT

Exemplary systems and methods for creating and sharing channels are provided. In exemplary embodiments, a channel having at least one loop with items of media is created by a user. Permissions for accessing and modifying the channel including the items of media and the loop are set by the user. Subsequent users may access and modify the channel subject to the permissions.

### CROSS-REFERENCE TO RELATED APPLICATIONS

The present application claims the benefit and priority of U.S. provisional patent application Ser. No. 60/644,254 filed on Jan. 13, 2005 and entitled “Systems and Methods for One Click Photo Sharing,” and U.S. provisional patent application Ser. No. 60/644,129, filed on Jan. 13, 2005 and entitled “Systems and Methods for Drag and Drop Loops,” which are herein incorporated by reference.

This application is related to co-pending U.S. application Ser. No. __/___, entitled “Systems and Methods for Providing Loops,” filed on Jul. 1, 2005, co-pending U.S. application Ser. No. ___/___, entitled “Systems and Methods for Single Act Media Sharing,” filed on Jul. 1, 2005, co-pending U.S. application Ser. No. ___/___, entitled “Systems and Methods for Providing an Interface for Interacting with a Loop,” filed on Jul. 1, 2005, co-pending U.S. application Ser. No. ___/___, entitled “Systems and Methods for Single Input Installation of an Application,” filed on Jul. 1, 2005, co-pending U.S. application Ser. No. ___/___, entitled “Systems and Methods for Sharing Loops,” filed on Jul. 1, 2005, and co-pending U.S. application Ser. No. ___/___, entitled “Loop Channels,” filed on Jul. 1, 2005, which are herein incorporated by reference.

### BACKGROUND OF THE INVENTION

1. Field of the Invention

The present invention relates generally to loops having media, and more particularly to systems and methods for creating and utilizing channels having loops.

2. Description of Related Art

Presently, people are accustomed to exchanging data in a plurality of methods. Users of computing devices share information via personal digital assistants (PDAs), mobile phones, and computers, for example. Information in the form of media is frequently shared among users so that they can present visual and/or audio media to other users. For example, a user can take a snapshot of a subject via a mobile phone, and send that snapshot to a friend's laptop.

Conventionally, media is communicated from one user to a second user through a long series of steps. For instance, the user may access a file containing the media in a directory on the user's computing device to locate the media the user wishes to share. Upon locating the media, the user may select the file, or right click on the file and select an option, such as “send file by electronic mail.” When the “send file by electronic mail” option is. selected, an electronic mail window opens in which the user can enter text and send the file containing the media to a second user. Alternatively, the user may open an electronic mail window, attach the file, and send an electronic mail message along with the attachment to the second user. The process of communicating media from one computing device to another can take several minutes, because of the number of steps involved in locating, addressing, and sending the media to specified users.

The second (receiving) user can then open the received file to view the media in the file. Typically, only one file may be opened and viewed at a time. Additionally, the second user may not know the content of the file until the file is opened.

Disadvantageously, the first user cannot control how the second user will use the received media. For example, the second user may modify the media and/or send the media to more users. Often times, modifications and further dissemination of the media occur without the knowledge of the first user.

Therefore, there is a need for a system and method for presenting loops. There is a further need to present multiple loops via channels.

### SUMMARY OF THE INVENTION

Exemplary systems and methods for creating and presenting channels are provided. In exemplary embodiments, a channel containing loops having items of media is created by a user. The items of media may comprise any audio or visual data such as, for example, photos, videos, movies, songs, graphics, or advertisement. When creating the channel, the user can provide various permissions for accessing the channel and modifying the channel, the loops, and items of media in the loops. The user can also provide permissions for further sharing rights (i.e., if a particular user is allowed to further share the channel).

In one embodiment, the user may allow the channel to be listed in a public directory. By doing so, the user will allow the general public to access the channel. The user, however, may still deny modifications to the channel via the permissions.

When the user attempts to modify the channel, a media engine or the server reviews the permissions for the channel to determine if the modifications are allowed for the particular user.

### BRIEF DESCRIPTION OF THE DRAWINGS

FIG. 1 is an exemplary screenshot of a loop on a loop player, in accordance with one embodiment;

FIG. 2 is an exemplary multi-channel loop player;

FIG. 3 is block diagram of an exemplary environment for practicing the present invention;

FIG. 4 is an exemplary block diagram of a media engine;

FIG. 5 is an exemplary block diagram of components associated with a server;

FIG. 6 is an exemplary flowchart of a method for creating and sharing a loop;

FIG. 7 is an exemplary flowchart of a method for creating and sharing a channel;

FIG. 8 is an exemplary flowchart for accessing and editing a channel; and

FIG. 9 is an exemplary flowchart for determining if a user has permissions to perform certain modifications to the channel.

### DESCRIPTION OF EXEMPLARY EMBODIMENTS

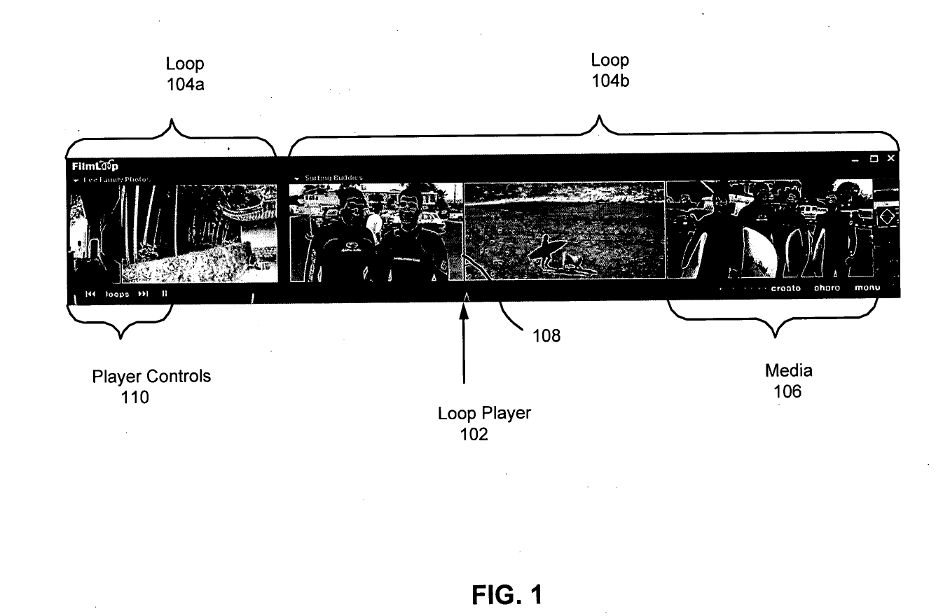

FIG. 1 is a screenshot of an exemplary loop player 102 operating on a computing device. The computing device may be, for example, a personal digital assistants (PDAs), mobile phones, or personal computer. The loop player 102 displays loops 104a, 104b, etc. Any number of loops 104 may be displayed by the loop player 102. In exemplary embodiments, the loops 104 scroll across the loop player 102.

Each loop 104 comprises various items of media 106. The media 106 may comprise photos, video, audio, images, text, advertisement, and any other type of data. The media 106 may appear as one or more items separated by a line, frame, or any other separation device 108 for defining the one or more items of media 106. Each item of media 106 may, itself, include moving displays, videos, or further media. The media 106 can be manipulated by the user, as will be described in more detail hereinafter.

As shown in the present embodiment, portions of two loops 104a and 104b are being displayed at the same time. A first loop 104a is entitled “Lee Family Photos,” while a second loop 104b is entitled “Surfing Buddies.” Within the second loop 104b, a plurality of media 106 items related to surfing are provided. For example, one item of media 106 of the second loop 104b is a photo of four surfers.

Player controls 110 are provided on the loop player 102 for manipulating movement and/or scrolling of one or more loops 104. The loops 104 may be manipulated by a user of the loop player 102 to stop, speed up, slow down, or change direction of the scrolling. The player controls 110 are exemplary, and any type of mechanism may be provided for manipulating the loop(s) 104. Furthermore, any type of manipulation of loops 104 is within the scope of embodiments of the present invention.

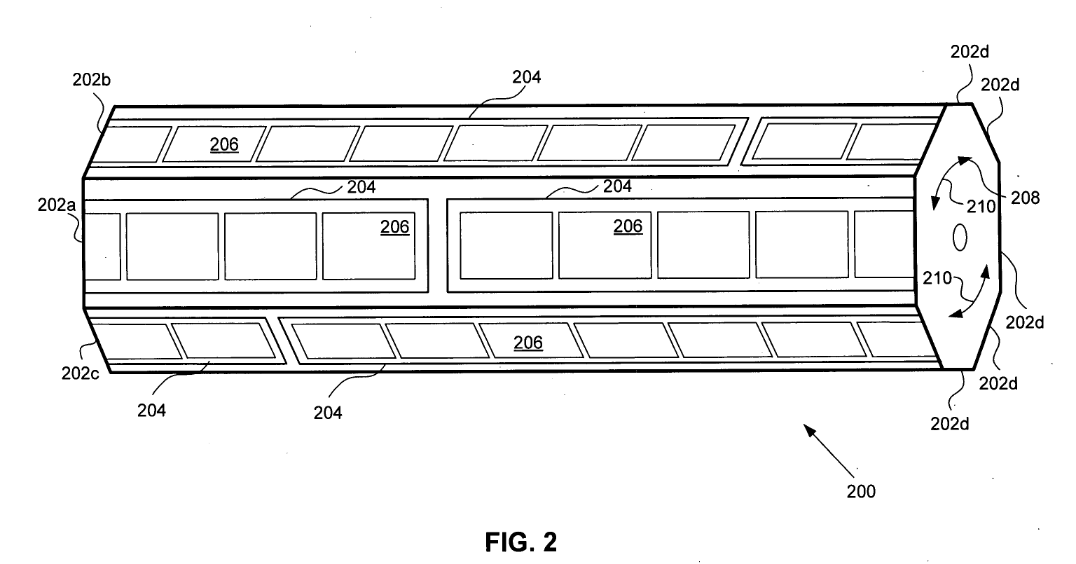

FIG. 2 shows an embodiment which expands the single display loop player 102 of FIG. 1 into a multi-channel loop player 200. The multi-channel loop player 200 is a graphical interface showing a plurality of channels 202, each channel 202 displaying at least one loop 204. Any number of loops 204, however, may be displayed in each channel 202, and any number of items of media 206 may be present in each loop 204.

In the present embodiment, the multi-channel loop player 200 displays channels 202 to give the user of the multi-channel loop player the appearance that the channels 202 are organized on a “drum.” Any number of channels 202 may be provided in alternative embodiments of the multi-channel loop player 200, and the various channels may be displayed in any way to help the user understand the organization and relationship of the channels. For example, the multi-channel loop player 200 may display the channels 202 stacked vertically, similar to a two dimensional television guide in a newspaper.

On the multi-channel loop player 200 of FIG. 2, only one of the channels 202 is visible to the user at any one time. In FIG. 2, the user has selected channel 202a for primary viewing. This selected channel 202a will be displayed in a front perspective view on the multi-channel loop player 200. As shown, non-selected channels 202b and 202c, which are adjacent to the selected channel 202a, would not be visible to the user of the multi-channel loop player 200. Additional channels 202d may or may not be viewable dependent on the shape of the multi-channel loop player 200.

The channel 202 may be selected by various methods. In one embodiment, channels in the multi-channel loop player 200 may appear rotatable to the user. Thus, the user may use a selection device (e.g., mouse) to click on a rotation direction (i.e., arrowhead 208) of a rotation arrow 210. Other rotation mechanisms may be provided on, or associated with, the multi-channel loop player 200. In a further embodiment, a channel dial, similar to a television channel dial, may be provided to select the channel. Alternatively, an input field may be provided on, or associated with, the multi-channel loop player 200 for entering a channel identifier. For example, if a channel 202b is assigned a channel identifier of “Vacation Destinations,” then the user may type in “Vacation Destinations” in the input field. Any type of channel identifier may be used including numbers, names, locations, events, text and number combinations, and so forth.

In further embodiments, the user may subscribe to channels 202. For example, a user may subscribe to a car channel 202 which provides loops 204 having items of media showing various types of cars. The channel subscription may be free or may require a subscription fee.

The process of providing an interface for interacting with a loop is described in further detail in co-pending U.S. application Ser. No. ___/___, entitled “Systems and Methods for Providing an Interface for Interacting with a Loop,” filed on Jul. 1, 2005, which is incorporated by reference.

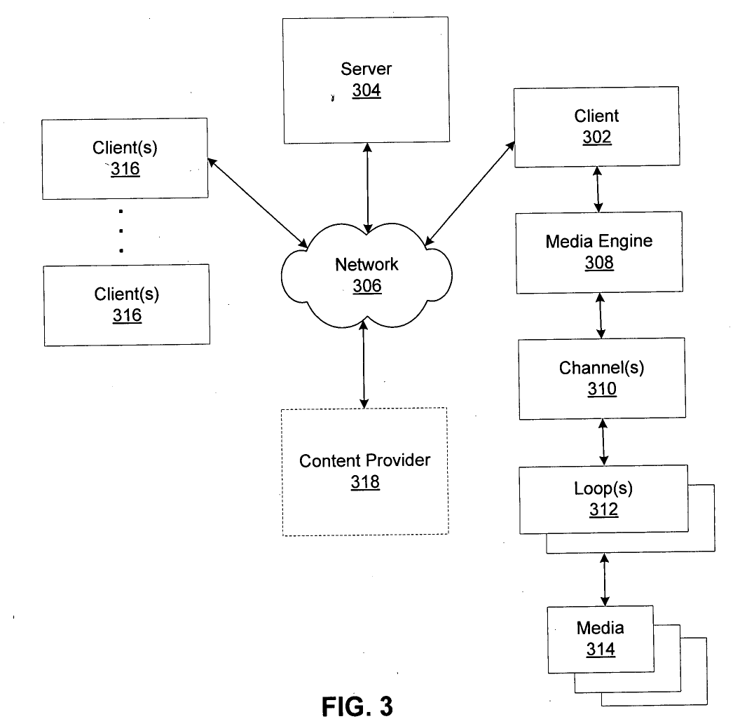

Referring now to FIG. 3, an exemplary environment for practicing embodiments of the present invention is shown. According to exemplary embodiments, the environment comprises a client 302 coupled to a server 304 via a network 306. The client 302 may be any computing device (e.g., laptop, mobile phone, PDA, etc.) associated with a user.

The client 302 is coupled to a media engine 308 that generates and/or manipulates at least one loop 312. The media engine 308 may also generate and/or manipulate channels 310 having the at least one loop 312. Additionally, the media engine 308 provides the loop player 200 (FIG. 2) for displaying the channels 310 and the at least one loop 312 on a display device of the client 302. In an alternative embodiment, the media engine 308 resides on the client 302. In yet a further embodiment, the media engine 308 is coupled to the client 302 via the network 306.

The media engine 308 is utilized to create loops 312 using items of media 314. Initially, a user at the client 302 creates an empty loop 312, and selects one or more items of media 314 from files located on, or coupled to, the client 302 to incorporate into the empty loop 312. For example, the client 302 may search for photos found on the Internet and provided these photos to the media engine 308, which then uses the photos to populate the loop 312. In one embodiment, the items of media 314 are provided to the loop 312 by dragging and dropping the items of media 314 into the loop 312. Alternatively, the user may initiate a command that the items of media 314 be used to populate the loop 312. In further embodiments, the user can drag a folder having a plurality of items of media 314 into the loop 312.

A user may also modify existing loops 312. Thus, the user may drag items of media 314 into or out of the existing loop 312 or drag a folder of media 314 items into or out of the existing loop 312. Alternatively, the user may initiate a command to add or remove items of media 314 from the existing loop 312. Any manner of identifying items of media 314 to add to, or remove from, the loop 312 is with in the scope of various embodiments. For example, the user may highlight the item of media 314 within the loop 312 and select a remove option from a drop down menu.

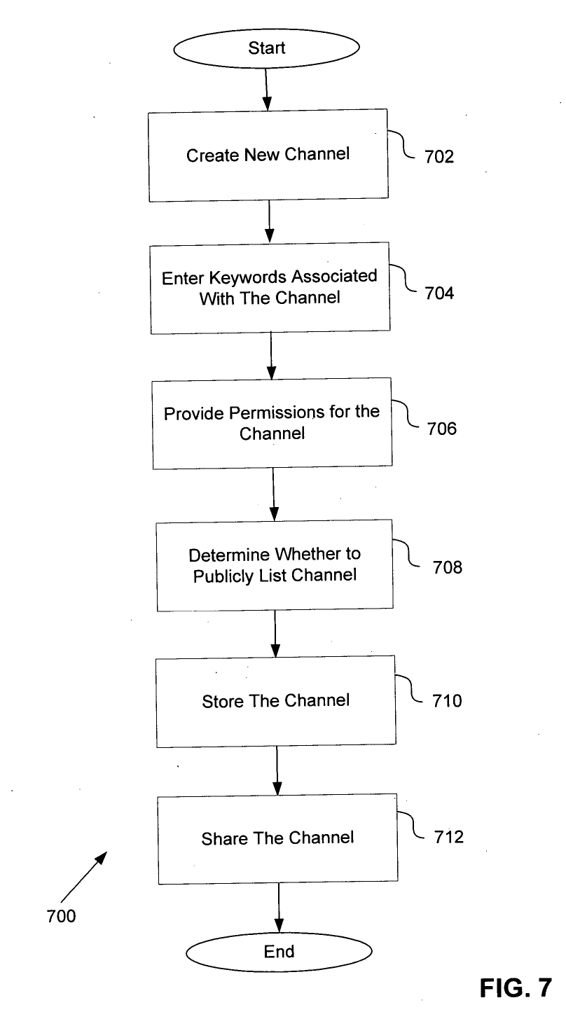

The user may also create a channel 310 for displaying at least one loop 312. The creation of a channel 310 will be discussed in more detail in connection with FIG. 7. In a manner similar to adding and removing items of media 314, the loops 312 may be added to, and removed from, the channels 310. Thus, the loop 312 may be dragged and dropped into the channel 310 or dragged and removed from the channel 310. Alternatively, the user may initiate a command that the loop 312 be used to populate the channel 310, or that the loop 312 should be removed from the channel 310.

In one embodiment, an empty channel 310 is first created. Then loops 312 are created and provided to the empty channel 310. In an alternative embodiment, the loops 312 are first created and then assigned to channels. If the assigned channel is preexisting, loop 312 is added to a preexisting channel 310. If, however, the channel does not exist, then the user may create the channel 310.

The exemplary media engine 308 may assign a channel identifier to each channel 310 it generates. Additionally, the media engine 308 may assign the channel identifier as well as a loop identifier to each loop 312 generated within the channel 310. Similarly, each item of media 314 in the channel 310 may receive the channel identifier, the loop identifier, and a media identifier. Thus, for example, the media engine 208 assigns a channel identifier to a generated channel 310 and assigns the channel identifier as well as a loop identifier and media identifiers to each of the items of media 314 used to generate the loop 312 in the channel 310. In exemplary embodiments, the media and loop identifiers are unique within the channels 310. Furthermore, the channel identifiers, loop identifiers, and/or the media identifiers may be unique within the network 306. In a further embodiment, the server 304 may assign the channel, loop, and media identifiers. The server 304 then communicates these identifiers to the media engine 308, so the media engine 308 can store and locate the identifiers.

When a user drags and drops-items of media 314 into a loop 312, the user is requesting the media engine 308 modify the loop 312 by adding the dropped items of media 314. Accordingly, the media engine 308 may assign an identifier that is unique within the loop 312 to each of the items of the media 314 dropped by the user. Because an item of media may be used in more than one loop 312, the items of media may have more than one identifier (e.g., one for each loop 312 in order to identify which loop 312 contains the item of media 314).

In a similar manner, when the user adds (e.g., drags and drops) the loop 312 to the channel 310, the loop 312 may be assigned a unique identifier within the channel 310. The loop 312, however, may be used in more than one channel 310. Thus, the loop 312 may have more than one identifier (e.g., a different identifier for each channel 310 the loop 312 is contained within).

The media engine 308 also updates loops 312 to reflect removal of items of media 314, and updates the channel 310 upon removal of loops 312 or items of media 314 in the loops 312. The media engine 308 may remove the corresponding identifiers of the removed items of media 314 or loops 312. Alternatively, the media engine 308 may alter the metadata of the removed items of media 314 or loops 312 to reflect the removal.

As previously discussed, the user may initiate a command that instructs the media engine 308 to create or modify channels 310. The process may involve the use of the identifiers. For example, the media engine 208 receives the media or loop identifier from the user for the channel 310, compares the media or loop identifier with identifiers stored by the media engine 308, and creates or modifies the channel 310 with the item(s) of media 314 or the loop 312 identified by the identifier. Similarly, the user may select a channel 310 to be modified by the channel identifier. Once identified, the user can then select the loop 312 or the items of media 314 (e.g., drag and drop, identifiers, copy and paste) to modify (e.g., add or remove) the channel 310 with. In alternative embodiments, the items of media 314, the loops 312, and the channels 310 may be identified by other criteria such as subject matter or title.

When changes are made to channel 310 (e.g., items of media 314 or loops 312 added, removed, or modified), the media engine 308 and the server 304 may store and/or track the changes as updates to the channel 310. For example, if the user resizes an image of an item of media 314, the media engine 308 and the server 304 can include the resized image as an update to the item of media 314 in the loop 312 in the channel 310. Furthermore, the media engine 308 or the server 304 may assign a new identifier to the resized image in the item of media 314.

In exemplary embodiments, a user of the client 302 may share one or more loops 312 and one or more channels 310 with further clients 316. The further clients 316 may also have, or be coupled to, media engines (same or similar to media engine 308) for playing the loops 312 in the channels 310, creating loops 312 and channels 310, modifying loops 312 and channels 310, or any other manipulation of loops 312 and channels 310 allowed. For example, a further client 234 may add a loop 312, add an item of media 314, remove a loop 312, remove an item of media 314, or modify metadata of the channel 310.

The process of sharing media is described in further detail in co-pending U.S. application Ser. No. ___/___, entitled “Systems and Methods for Sharing Loops,” filed on Jul. 1, 2005, which is incorporated by reference.

When a user from the client 302 makes a modification to the channel 310 (e.g., a modification to a loop 312 in the channel 310) having an identifier shared by the channel 310 at the client(s) 316, the client(s) 316 receives the same modifications to the channel 310. The server 304 can provide the modifications to the channel 310 on the client(s) 316 automatically at any time after the user at the client 302 makes the modification to the channel 310. Because the server 304 may automatically distribute modifications to the client(s) 316 with channel 310 having the same identifier, only a single act is required by the modifying user to share the modifications with users at the client(s) 316. According to one embodiment, the server 304 makes requests to the media engine 308 coupled to the client 302 at various times for changes made to the channel 310 by the client 302. In an alternative embodiment, the server 304 waits for a notification from the client 302 of the modification to the channel 310, and then provides the modification to the client(s) 316 that have channels 310 with the same identifier. As discussed herein, the updates may include any modification to the media 314, the loop 312 comprising the media 314, the channel 310 comprising the loop 312 and items of media 314, and/or metadata associated with the channel 310, loops 312, or items of media 314.

In exemplary embodiments, master copies of the channels 310 and the-loops 312 may be stored on the server 304. Further, the server 304 may comprise an index for locating the master copy of channel 310 or the loop 312. In one embodiment, the index may comprise a list of identifiers. The users at the clients 302 and 316 can modify the master copy on the server 304 by accessing the server 304 via the network 306. Alternatively, the master copy of the channel 310 or the loop 312 may be stored at the server 304, while the clients 302 and 316 utilize an index to retrieve the particular channel 310 or loop 312 to their computing device for viewing and modification. Any storage medium may be utilized for storing the loop 312, copies of the loop 312, channels 310, copies of the channels 310, metadata, and/or indices.

In another embodiment, the server 304 may store versions of the channels 310 and loops 312. Thus, the server 304 may maintain different versions of the same channels 310 and loop 312. In a further embodiment, the client 302 or 316 may store different versions of the channels 310 loop 312 created by the client 302 or 316 or of shared channels 310 and loops 312. Both the server 304 and the clients 302 and 316 may maintain an index for organizing and tracking the various versions of the channels 310 and loops 312. The identifiers assigned to the different versions may, in exemplary embodiments, be similar to reflect the version (e.g., identifier#.1 for the first version and identifier#.2 for the second version).

In another embodiment, the media engine 308 associated with the client 302 assigns a temporary identifier to the items of media 314 and loops 312 added (e.g., dragged and dropped) to the channel 310. The client 302 then forwards the added items of media 314 or loops 312 with the temporary identifier to the server 304. The server 304 then assigns a permanent identifier to the item of media 314 or loop 312 before forwarding the item of media 314 or loop 312 with the permanent identifier back to the client 302 and/or the further clients 316 as a modification. The temporary and permanent identifier associated with the item of media 314 and loop 312 may also be associated with the identifier assigned to the corresponding channel 310.

The process of providing loops is described in further detail in co-pending U.S. application Ser. No. ___/___, entitled “Systems and Methods for Providing Loops,” filed on Jul. 1, 2005, which is incorporated by reference. The process of dragging and dropping media 212 within the loop 210 is described in further detail in co-pending U.S. application Ser. No. ___/___, entitled “Systems and Methods for Single Act Media Sharing,” filed on Jul. 1, 2005, which is also incorporated by reference.

It will be appreciated by those skills in the art that the clients 302 and 316 may be a part of a peer-to-peer network where no external server 304 is necessary. In some embodiments, the client 302 on a peer-to-peer network assigns an identifier to the channel 310, loop 312, and the items of media 314 contained within the loop 312. Further, the client 302 may share the channel 310, the loop 312, and the items of media 314 with the client(s) 316. In other embodiments, the client 302 functions as a server 304 on a peer-to-peer network. For example, the client 302 may function as a server 304 for all channel(s) 310 created on the client 302. In this example, the client 302 will assign permanent identifiers for the items of media 314 within the loop 312 as well as the loop 312, itself. Similarly, client 316 will operate as a server 304 for channel(s) 310 created on the client 316.

The further client(s) 316 may also create and modify channels 310 and loops 312. Channel and loop creation and modification by the client(s) 316 are in the same manners as that of the client 302, as previously described. Thus, the clients 302 and 316 are capable of performing similar or identical functions with respect to the channels 310 and loops 312.

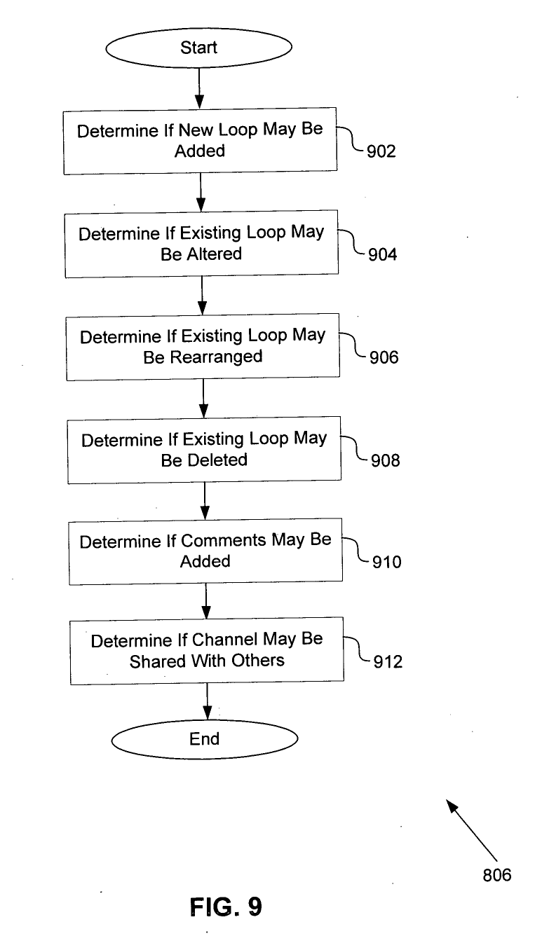

The user associated with the client 302 or 316 that creates the channel 310 can create permissions for the channel 310. The permissions determine which clients 302 or 316 can access the channel 310, make modifications to the accessed channels 310, or share the channels 310. Permissions will be discussed in more detail in connection with FIG. 9.

At least one, optional content provider 318 may be coupled to the network 306. The content provider 318 provides various content to the loop 312 and/or the channel 310 (e.g., advertisements). In one embodiment, each loop 312 in the channel 310 includes at least one item of media from the content provider 318. Accordingly, the loop 312 may display advertisements or other content along with the items of media 314 displayed by the loop 312. In an alternative embodiment, the content provider 318 provides a loop 312 to the channel 310. Thus, for example, an entire advertisement loop 312 may be displayed in the channel 310. The content provider 318 can specify, according to one embodiment, how often its content appears within the loop 312 or the channel 310. If the content provider 318 modifies the content, the server 304 or content provider 318 distributes the modified content as updates to the loops 312 (e.g., modified content replaces previous version of content) or the channel 310.

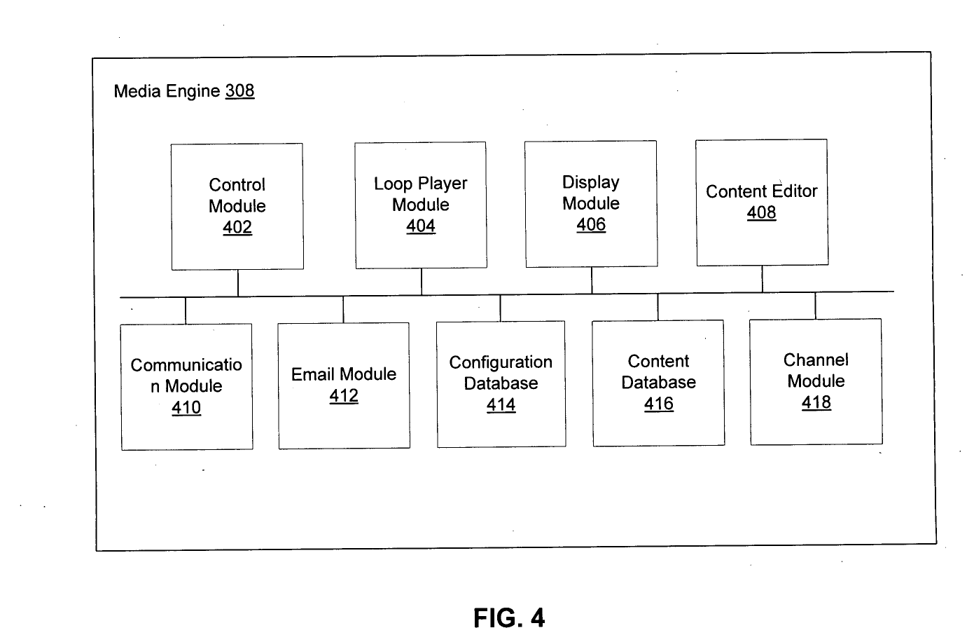

Referring now to FIG. 4, a block diagram of an exemplary media engine 308 is shown. A control module 402 manipulates the items of media 314 (FIG. 3) and constructs loops 312 (FIG. 3) having the items of media 314. The control module 402 further constructs the channels 310 having the constructed loops 312. The control module 402 can also specify a default speed at which the loops 312 play in the channel 310. Additionally, the control module 402 may coordinate the insertion, at specific times or intervals, of specified items of media from the content provider 318 (FIG. 3) into the loops 312 of the channel 310, or the insertion of a specific loop into the channel 310.

A loop player module 404 plays the loops 342 in the channel 310 and receives user inputs to modify the display and contents of the channel 310. Thus, the loop player module 404 receives inputs from the user to create loops 312 and channels 310, modify items of media 314 or the loops 312 in the channel 310, and/or remove items of media 314 or loops 312 from the channel 310. In exemplary embodiments, the user may choose from on-screen selections (e.g., buttons or drop down menus), manipulate on-screen items (e.g., dragging and dropping items of media 314 or loops 312), or issue voice commands to create or modify loops 312 or channels 310. In one example, the loop player module 404 may also be used to control a direction and speed the loop 312 plays in the channel 310. For example, when the user uses player controls (similar to the player controls 110 of FIG. 1) to adjust the loop 312, the loop player module 404 receives the instructions from the player controls and adjusts the loop 312 accordingly.

A display module 406 presents a graphical user interface (GUI) through which the multi-channel loop player 200 (FIG. 2) may be displayed. Within the multi-channel loop player 200, any number of channels 310 having any number of loops 312 within each channel 310 may be viewed. The display module 406 also provides various modification interfaces on the multi-channel loop player 200 through which users may modify the channels 310, loops 312, or items of media 314. Such modification interfaces include, for example, drop down menus and player controls.

A content editor 408 allows the user to make adjustments to items of media 314 and loops 312 within the channel 310. Thus, the user can use the content editor 408 to resize, rotate, configure, or format the items of media 314 or the loop 312. For example, the user may resize an image or change a font type associated with the item of media 314. Any type of editing to the item of media 314 or the loop 312 may be accomplished using the content editor 408.

An exemplary communication module 410 allows the media engine 308 to utilize facilities of the client 302 (FIG. 3) for communicating with the server 304 (FIG. 3). The communications may include providing and receiving updates for the channels 310 running in the media engine 308, and to transfer any other data between the media engine 308 and the server 304.

An email module 412 may be provided as a communication interface for electronic mails. The email module 412 is utilized to send channels 310, loops 312, items of media 314, metadata, or identifiers associated with the channels 310, loops 312 and items of media 314 directly to other users. In a further embodiment, the email module 412 may also send invitations to other users to access shared channels 310.

The exemplary media engine 308 may comprise a configuration database 414. The configuration database 414 stores identifiers associated with the items of media 314, loops 312, and channels 310. In further embodiments, the configuration database 414 stores any type of data related to the channels 310 (e.g., information regarding the client 302, type and quality of attached network, communication performance, registration information for the client 302, preferences of the user at the client 302, version numbers for the loops 312). In a further embodiment, the configuration database 414 may be located outside of the media engine 308, and is accessible via a configuration database interface in the media engine 308.

The exemplary media engine 308 may also comprise a content database 416. The content database 416 stores the items of media 314 and the loops 312 used in the channels 310. Any process for storing and/or locating the items of media 314 and loops 312 may be utilized in association with the content database 416. For example, a hash function may be utilized to index and retrieve the items of media 314 from the content database 416. In a further embodiment, the content database 416 may be located outside of the media engine 308, and is accessible via a media database interface in the media engine 308.

An exemplary channel module 418 may also be provided. In one embodiment, the channel module 418 keeps track of which loops 312 should be playing in each channel 310 of the player (e.g., multi-channel player 200 of FIG. 2). The channel module 418 may also maintain subscription information for each channel 310 stored on, or accessed by, the media engine 308.

The exemplary media engine 308 shown in FIG. 4 is described as including various components. Alternative embodiments may comprise more or fewer components that those shown and still fall within the scope of embodiments of the present invention.

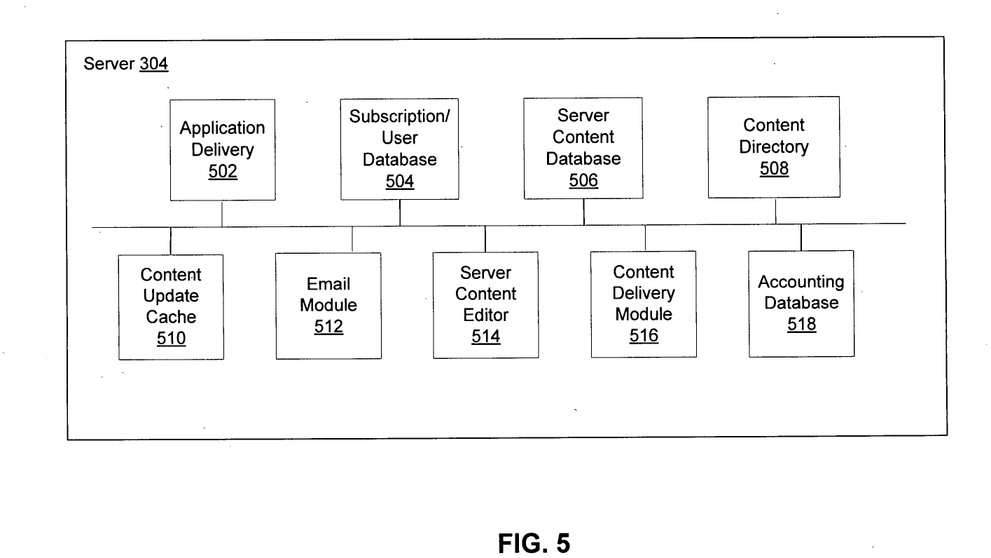

FIG. 5 shows an exemplary embodiment of the server 304 comprising various components associated with providing channels 310 (FIG. 2). An application delivery module 502 is provided for delivering the channels 310, the loops 312, and items of media 314 (FIG. 3) that comprise the channel 310, and updates (e.g., modifications) to the channel 310 to the appropriate client (e.g., clients 302 and 316). In an embodiment where the server 304 creates the channel 310 or maintains a master copy, the server 304 can send the channel 310 to the media engine 308 (FIG. 3) via the network 306 (FIG. 3). The application delivery module 502 may also deliver identifiers assigned to the channel 310, loop 312, and the items of media 314 to clients 302 and 316.

The exemplary server 304 also comprises various databases including a subscription/user database 504. The subscription/user database 504 stores user information, such as name, email addresses, user identifiers, and any other data relevant for the user. The subscription/user database 504 may also store information associated with channels 310 and loops 312 created by the user or received from other users, and items of media 314 provided by the user. The user may be required to register certain information with the server 304 before the server 304 will provide channels 310 to the multi-channel loop player 200 (FIG. 2) associated with the user. Alternatively, the user may be required to register in order to access the identifiers for the items of media 314, the loops 312, and/or the channels 310.

In one embodiment, the subscription/user database 504 contains channel subscription information for each user. Thus, a user may subscribe to a public or private channel 310. The user will then receive all the loops 312 in the subscribed-to channel 310. Furthermore, if any modifications are made to a loop 312 in the subscribed-to channel, then the user will automatically receive those changes as updates to their channel 310. In some embodiments, a channel provider will charge a fee for subscribing to their channel 310.

Another database of the server 304 is a server content database 506 which may store items of media 314, loops 312, channels 310, and metadata or configuration information associated with the items of media 314, the loops 312, and channels 310. As discussed herein, the items of media 314 in the loops 312 of the channel 310 may include, for example, photographs, music, graphics, streaming media, animation, movies, graphics, and any other type of visual or audio data.

A content directory 508 may be provided for indexing the content stored in the server content database 506. For example, a channel 310 associated with the word “surfing” (e.g., in the title) may be retrieved from the server content database 506 via a search of the index in the content directory 508. Any indexing and searching mechanism is within the scope of various embodiments of the present invention. In a further embodiment, the content directory 508 may be included in the server content database 506.

A content update cache 510 stores the items of media 314 and loops 312 that are utilized to update or modify existing channels 310. According to one embodiment, the content update cache 510 will store the items of media 314 and loops 312 that are currently being used to modify the channels 310. In an alternative embodiment, the content update cache 510 will store some or all items of media 314 and loops 312 used to modify the channel 310.

An email module 512 may send electronic mails for the user at the client 302 to one or more other clients 316 (FIG. 3), and vice-versa. These emails will provide the receiving client with information for retrieving the items of media 314 or the loops 312, and for constructing the channels 310. Alternatively, the email module 512 may receive electronic mails from the users at the clients 302 and 316. The electronic mails may comprise commands or requests to the server 304, for example, adding a loop 312 to a channel 310.

A server content editor 514 allows for modification of the items of media 314 and loops 312 similar to that of the content editor 408 (FIG. 4) on the media engine 308. In this situation, however, the user modifies the items of media 314 or loops 312 using the server content editor 514 via the server 304 instead of, or in addition to, the content editor 408. For example, the server content editor 514 may be used to resize photos, remove red eye, correct color balance, and so forth.

An exemplary content delivery module 416 provides content to be included as one or more items of media 212 in the loop 210 or as one or more loops in the channel 310. In one embodiment, the content delivery module 416 accesses content stored on, or associated with, the server 204 for the content. In an alternative embodiment, the content may be provided from the content provider 216 (FIG. 2). In this alternative embodiment, the content delivery module 416 may not be utilized.

In one embodiment, the advertising or content from the content delivery module 516 (or content provider 318 of FIG. 3) is provided based on an analysis of the user of the channel 310 or the channel 310, itself. For example, an advertisement for a family vacation to Disneyland® may be included in a family related channel 310. Any manner of determining advertisement or content to be provided, however, may be employed.

The server 304 may also include an accounting module 518. The accounting module 518 may track the loops 312 and the frequency and type of interaction each of the users has with the channels 310. Specifically, the accounting module 518 can track interaction between the user and the advertisement content included in the channel 310. Accordingly, the accounting module 518 can track monies owed to or from a provider of the advertisement content based on the user interactions.

Although the server 304 has been described as including various components, more or fewer components may comprise the server 304 in accordance with alternative embodiments. For example, the server 304 may further include a search engine component or a communication interface.

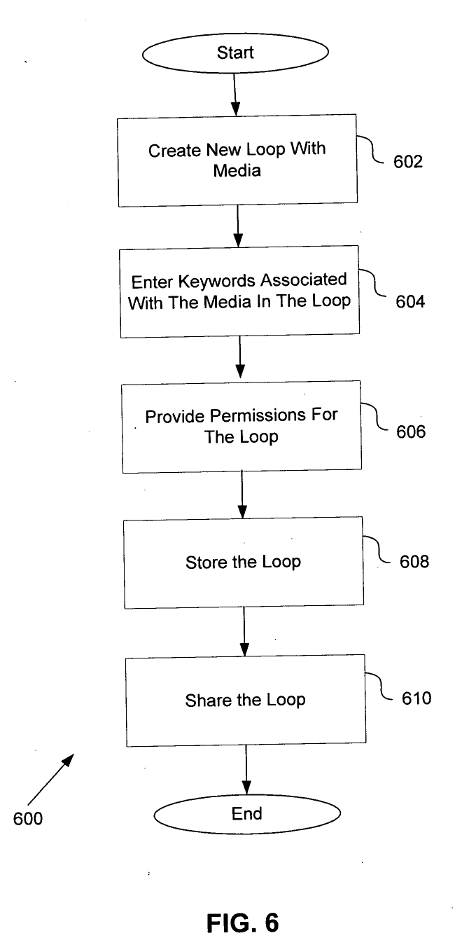

Referring now to FIG. 6, an exemplary flowchart 600 of a method for creating and sharing a loop is shown. In step 602, the media engine 308 (FIG. 3) (or the server 304 of FIG. 3) creates a new loop 312 (FIG. 3) having items of media 314 (FIG. 3). The media engine 308 creates the new loop 312 based on inputs received from a user. When creating the new loop 312, the user adds one or more items of media 314 into an empty new loop 312. Additionally, the user may enter a title for the new loop 312.

In optional step 604, the media engine 308 receives keywords associated with the items of media 314 in the loop 312. The keywords may represent, for example, a topic, theme, events, or locations of the item of media 314 or the loop 312.

In step 606, the media engine 308 receives permissions associated with the new loop 312. The permissions may include permissions for accessing the new loop 312 and for making modifications to the new loop 312. The modifications permissions for the new loop 312 may include permissions for adding or removing items of media 314 from the loop 312, altering items of media 314 in the loop 312, and rearranging an order of the item of media 314 in the loop 312. Further permissions may include allowing addition of comments to the items of media 314 and allowing further sharing of the loop 312. Any permissions related to accessing and modifying the loops 312 are within the scope of exemplary embodiments.

The media engine 308 then receives instructions as to whether to publicly list the new loop 312 in step 608. Publicly listing the new loop 312 will include the loop 312 in a public directory that may be accessed by the public. Other users may then access the publicly listed loop 312 and add the loop 312 to one of their channels 310, for example.

In step 610, the media engine 308 stores the new loop 312. In some embodiments, the loop 312 may be stored locally in a storage device associated with the client 302 (FIG. 3) being used by the user to create the loop 312. In other embodiments, the loop 312 is stored on a storage device associated with the server 304 (FIG. 3). In yet further embodiments, the loop 312 may be stored both locally and on the server 304. Additionally, a master copy of the loop 312 may be maintained on either the local storage device or on the server 304.

Once created, the loop 312 can be shared in step 612. In one embodiment, the sharing may occur via the public directory as discussed in step 608. Alternatively, the user may send (e.g., email) a copy of the loop 312 to at least one other user, or send an invitation having an identifier (for the shared loop 312) to further users. The loop 312 may also be incorporated into a preexisting or new channel 310 which may be shared. Other methods of sharing loops 312 are contemplated by embodiments of the present invention.

Referring now to FIG. 7, is an exemplary flowchart 700 of a method for creating and sharing a channel is shown. In step 702, the media engine 308 (FIG. 3) (or the server 304 of FIG. 3) creates a new channel 310 (FIG. 2) having loops 312 (FIG. 3). The media engine 308 creates the new channel 310 based on inputs received from a user. When creating the new channel 310, the user adds one or more loops 312 into an empty new channel 310. Additionally, the user may title the new channel(s) 310.

In optional step 704, the media engine 308 receives keywords associated with the channel 310. The keywords may represent, for example, a topic, theme, events, or locations of the channel(s) 310.

In step 706, the media engine 308 receives permissions associated with the new channel 310. The permissions may include permissions for accessing the new channel 310, and for making modifications to the new channel 310. The various channel permissions will be discussed in more detail in connection with FIG. 9.

The media engine 308 then receives instructions as to whether to publicly list the new channel 310 in step 708. Publicly listing the new channel 310 will include the channel 310 in a public directory that may be accessed by the general public. Other users may then access the publicly listed channel 310 and play the channel 310 on their loop player (e.g., the multi-channel loop player 200 of FIG. 2).

In step 710, the media engine 308 stores the new channel 310. In some embodiments, the channel 310 may be stored locally in a storage device associated with the client 302 (FIG. 3) being used by the user to create the channel 310. In other embodiments, the channel 310 is stored on a storage device associated with the server 304 (FIG. 3). In yet further embodiments, the channel 310 may be stored both locally and on the server 304. Additionally, the local storage device or the server 304 may maintain a master copy of the channel 310.

Once created, the channel 310 can be shared in step 712. In one embodiment, the sharing may occur via the public directory as discussed in step 708. Alternatively, the user may send (e.g., email) a copy of the channel 310 to at least one other user, or send an invitation having an identifier (for the shared channel 310) to further users. Other methods of sharing channels 310 are contemplated by embodiments of the present invention.

In one embodiment, the channel 310 is created before the loops 312 associated with the channel 310 are created. In an alternative embodiment, the loops 312 are first created, and then assigned to one or more channels 310. The channel may be preexisting (e.g., dragging and dropping the new loop 312 into the preexisting channel 310) or the channel may need to be created.

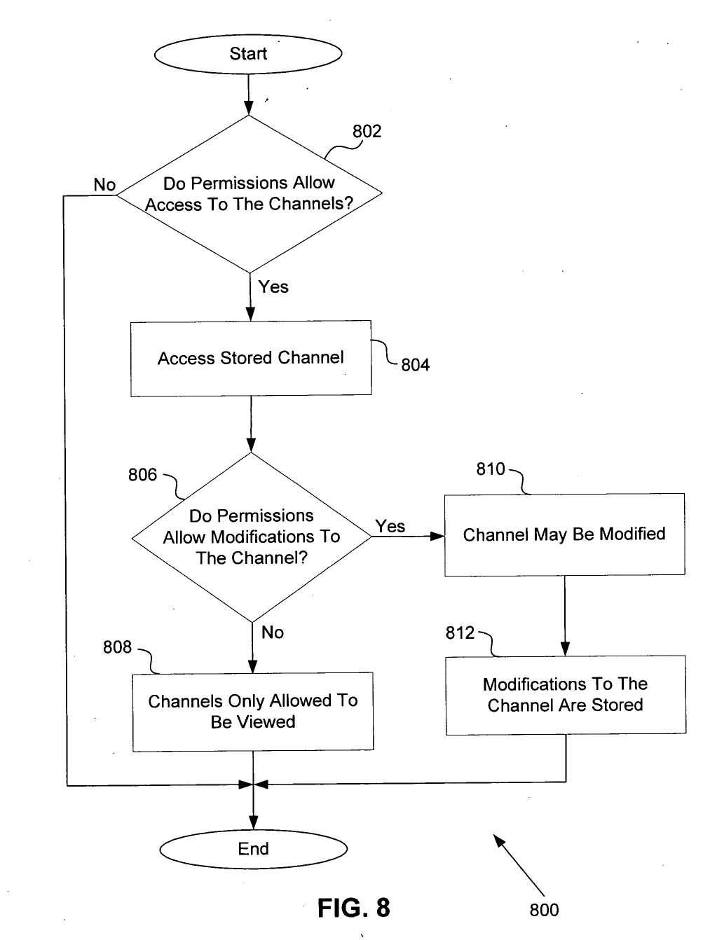

An exemplary flowchart 800 of a method for accessing and editing a channel 310 is shown in FIG. 8. A further user may attempt to access a shared channel 310. In one embodiment, the further user may search (e.g., using keywords) a public directory for the channel 310. Alternatively, the further user may receive an invitation having a ticket identifier for the channel 310. In this case, the further user provides the ticket identifier to the media engine 308 (FIG. 3) or the server 304 (FIG. 3) in order to retrieve the channel 310 and its contents. In another embodiment, the further user provides an item of media 314 or loop 312 containing a ticket identifier to the media engine 308 or the server 304 in order to retrieve the channel 310 and its contents. For example, the further user may provide an image file that contains the ticket identifier to the media engine 308, which then locates the ticket identifier in the image file, then retrieves the channel 310 (and its contents) that is associated with the ticket identifier. Any means of providing the media engine 308 with a ticket identifier is within the scope of this invention

In step 802, the server 304 or the media engine 308 associated with the further user determines if the permissions of the channel 310 the further user is attempting to access allows the further user to access the channel 310. As previously discussed, a creating user may set permissions for the channel 310 that limit access to the channel 310 by further users. If permissions do not allow access by the further user, the further user is denied access. If the further user has permission to access the channel 310, the channel 310 is presented to the user in step 804. Thus, the channel 310 may appear in a single channel loop player 102 (FIG. 1) or a multi-channel loop player 200 (FIG. 2) associated with the further user.

Should the further user attempt to modify the channel 310 (i.e., modifications to the channel 310, modifications to the loop(s) 312 or the items of media 314 within the loop(s) 312 of the channel 310, or metadata associated with the channel 310, loops 312, or items of media 314), the media engine 308 or the server 304 determines if the further user has permission to modify the channel 310 in step 806. As previously discussed, the creating user may set permissions for allowing modifications to the channel 310. If the further user does not have permission to modify the channel 310, the further user is only allowed to view the channel 310 in step 808. Alternatively, if the further user does have permission to modify the channel 310, then in step 810, the further user may modify the channel 310.

The modifications to the channels 310 are then stored in step 812. The modified channels 310 may be stored as versions of the original channels 310 or as new channels. The modified channels may be stored on a storage device associated with the client 316 (FIG. 3) of the further user or the server 304. In further embodiments, the modifications to the channel 310 may be sent back to the creating user (e.g., at client 302) and to all other users 316 subscribed to the same channel 310.

Referring now to FIG. 9, the step of determining if the further user has permission to modify the channel 310 (step 806 of FIG. 8) is described in more detail. In exemplary embodiments, the media engine 308 (FIG. 3) or the server 304 (FIG. 3) compares an attempted modification by the further user against the permissions associated with the channel 310. Thus, if the further user attempts to add a new loop 312 (FIG. 3) to the channel 310, the media engine 308 or the server 304 determines if the permissions of the channel 310 allow the further user to added the new loop 312 in step 902.

Similarly, if the further user attempts to alter the loop 312 (e.g., resize the loop 312, change font size, red eye reduction of an item of media 314 of the loop 312, etc.), in step 904, the media engine 308 or the server 304 determines if the permissions allow altering the existing loop 312 by the further user.

In step 906, the media engine 308 or the server 304 determines if the further user may rearrange an order of the loops 312 in the channel 310. For example, the further user may want to move the third loop 312 to after the fifth loop 312.

The media engine 308 or the server 304 may also determine if existing loops 312 may be deleted in step 908. Thus, when the further user attempts to drag an existing loop 312 out of the channel 310, for example, the delete permission for the channel 310 is reviewed.

The media engine 308 or the server 304 also determines if the further user in step 910 may add comments may. The further user may comment on the channel 310, a loop 312 in the channel 310, or on each item of media 212 within the channel 310. The comments are added by selecting (e.g., right click and select “comment” option) the channel 310, the loop 312, or the item of media 314 to be commented on, which will bring up a comment window. The further user may then add comments via this comment window.

The media engine 308 or the server 304 may also determine, in step 912, if the further user may share the channel 310 with additional users. While the creating user may want to share the channel 310 with the further user, the creating user may not want the further user to share the channel 310 with any one else. Accordingly, this further sharing permission will be set negatively for the channel 310.

The channel permissions discussed in relations to FIG. 9 are exemplary and may be practiced in any order. Furthermore, other channel permissions may be utilized and still fall within the scope of embodiments of the present invention.

The above-described functions can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with the invention. Those skilled in the art are familiar with instructions, processor(s), and storage medium.

The invention has been described with reference to exemplary embodiments. It will be apparent to those skilled in the art that various modifications may be made and other embodiments can be used without departing from the broader scope of the invention. Therefore, these and other variations upon the exemplary embodiments are covered by the present invention.

What is claimed is:

1. A method for creating a sharable channel, comprising:
incorporating at least one loop into a channel;
receiving permissions for access and modification rights to the channel from a creating client;
storing the channel; and
allowing the channel to be shared in accordance with the access and modification rights.

2. The method of claim 1 wherein the access and modification rights comprise allowing a new loop to be added to the channel.

3. The method of claim 1 wherein the access and modification rights comprise allowing alterations to the at least one loop in the channel.

4. The method of claim 1 wherein the access and modification rights comprise allowing an order of the at least one loop to be rearranged in the channel.

5. The method of claim 1 wherein the access and modification rights comprise allowing deletion of a loop from the channel.

6. The method of claim 1 wherein the access and modification rights comprise allowing comments to be added to the channel.

7. The method of claim 1 wherein the access and modification rights comprise allowing the channel to be shared with further clients.

8. The method of claim 1 wherein allowing the channel to be shared comprises listing the channel in a public directory.

9. The method of claim 1 wherein allowing the channel to be shared comprises sending an invitation having a channel identifier to at least one other client.

10. The method of claim 1 wherein incorporating at least one loop into the channel comprises a single act performed by a user.

11. The method of claim 10 wherein the single act comprises drag and drop of a loop into the channel.

12. The method of claim 10 wherein the single act comprises an audio instruction.

13. The method of claim 10 wherein the single act comprises clicking a button.

14. A method for allowing access and modification rights to a channel, comprising:
receiving a request from a client for access to the channel;
determining if the client has permission to access the channel; and
providing access to the channel if the client has access permission.

15. The method of claim 14 wherein determining if the client has access permission comprises checking a permission set associated with the channel.

16. The method of claim 14 further comprising determining if the client has permission to make modifications to the channel, and allowing the client to make edits to the channel if the client has modification permission.

17. The method of claim 16 wherein determining if the client has modification permission comprises checking a permission set associated with the channel.

18. The method of claim 16 wherein allowing the client to make modifications comprises a single act by a user at the client.

19. The method of claim 16 further comprising automatically updating the channel for all subscribers when a modification is made to the channel.

20. The method of claim 14 wherein the request for access to the channel comprises a channel identifier.

21. A multi-channel graphical user interface, comprising:
a plurality of channels, each channel displaying at least one loop; and
a mechanism to select one of the plurality of channels to display.

22. The channel graphical user interface of claim 21 wherein the plurality of channels are organized in a rotatable drum display.

23. The channel graphical user interface of claim 21 wherein the mechanism to select one of the plurality of channels is a channel rotator.

24. The channel graphical user interface of claim 21 wherein the mechanism to select one of the plurality of channels is a channel dial.

25. The channel graphical user interface of claim 21 wherein the mechanism to select one of the plurality of channels is a channel input field.

26. The channel graphical user interface of claim 21 wherein the mechanism to select one of the plurality of channels is receiving an audio instruction selecting one of the plurality of channels.
